(19) United States
(12) Patent Application Publication
(10) Pub. No.: US 2014/0192187 A1
(43) Pub. Date: Jul. 10, 2014

(54) NON-CONTACT MEASUREMENT DEVICE

(71) Applicant: Faro Technologies, Inc., Lake Mary, FL (US)

(72) Inventors: Paul C. Atwell, Lake Mary, FL (US); Frederick John York, Longwood, FL (US); Clark H. Briggs, DeLand, FL (US)

(73) Assignee: Faro Technologies, Inc., Lake Mary, FL (US)

(21) Appl. No.: 14/149,888

(22) Filed: Jan. 8, 2014

Related U.S. Application Data
(60) Provisional application No. 61/750,124, filed on Jan. 8, 2013.

(51) Int. Cl. G01B 11/03

(52) U.S. Cl. CPC G01B 11/03
USPC 348/136

(57) ABSTRACT

A portable coordinate measuring machine for measuring the coordinates of an object in space is provided including a manually positionable articulated arm portion having a plurality of connected arm segments that include position transducers that provide position signals. A probe assembly connected to an arm segment includes a non-contact measurement device having a projector and a camera separated by a baseline distance. The projector includes a light source that emits a line of light. The camera includes an image sensor having an array of pixels that receives the light reflected from the object in a sensor plane. A first processor of the camera, coupled to the image sensor, determines centroids from the received light. A second processor coupled to the first processor determines three-dimensional coordinates of points on the object based at least in part on the centroids provided by the processor, the positions, and the baseline distance.

### CROSS-REFERENCE TO RELATED APPLICATIONS

This application claims the benefit of U.S. provisional patent application Ser. No. 61/750,124 filed Jan. 8, 2013, the entire contents of which are incorporated herein by reference.

### BACKGROUND

The present disclosure relates to a coordinate measuring machine and, more particularly, to a non-contact measurement device of a portable articulated coordinate measuring machine.

Portable articulated arm coordinate measuring machines (AACMMs) have found widespread use in the manufacturing or production of parts where there is a need to rapidly and accurately verify the dimensions of the part during various stages of the manufacturing (e.g. machining) or production of the part. Portable AACMMs represent a vast improvement over known stationary or fixed, cost-intensive, and relatively difficult to use measurement installations, particularly in the amount of time it takes to perform dimensional measurements of relatively complex parts. Typically a user of a portable AACMM simply guides a probe along the surface of the part or object to be measured. The measurement data are then recorded and provided to the user. In some cases, the data are provided to the user in visual form, for example, three dimensional (3-D) form on a computer screen. Alternatively, the data may be provided to the user in numeric form, for example, when measuring the diameter of a hole, the text “Diameter=” is displayed on a computer screen.

Three-dimensional surfaces may be measured using non-contact techniques as well. One type of non-contact device, sometimes referred to as a laser line probe or laser line scanner, emits a laser light either on a spot, or along a line. An imaging device, such as a charge-coupled device (CCD) for example, is positioned adjacent the laser. The laser is arranged to emit a line of light which is reflected off of the surface. The surface of the object being measured causes a diffuse reflection which is captured by the imaging device. The image of the reflected line on the sensor will change as the distance between the sensor and the surface changes. By knowing the relationship between the imaging sensor and the laser and the position of the laser image on the sensor, triangulation methods may be used to measure three-dimensional coordinates of points on the surface. One issue that arises with laser line probes, is that the density of measured points may vary depending on the speed at which the laser line probe is moved across the surface of the object. The faster the laser line probe is moved, the greater the distance between the points and a lower point density. With a structured light scanner, the point spacing is typically uniform in each of the two dimensions, thereby generally providing uniform measurement of workpiece surface points.

The amount of data produced by a non-contact device is determined by the pixel resolution and the frame rate of the imaging device. It is desirable to scan at fast frame rates with high resolution cameras, because this reduces the amount of time required to accurately perform a part scan. However, the amount of information capable of being transmitted from the camera to a processing device is limited by the data transfer rates of current communication technology.

### SUMMARY

According to one embodiment of the invention, a portable coordinate measuring machine is provided for measuring three-dimensional coordinates of an object in space. The coordinate measuring machine includes a manually positionable articulated arm portion having opposed first and second ends, the arm portion including a plurality of connected arm segments, each arm segment including at least one position transducer for producing a position signal; a base section connected to the second end; a probe assembly connected to the first end, the probe assembly including a housing, a first processor, a projector, and a camera: the first processor disposed within the housing; the projector disposed within the housing, the projector having a light source configured to emit a first light onto a surface of the object, the projector being configured to project the first light to form a line on a plane arranged perpendicular to the direction of propagation of the first light; the camera arranged within the housing, the camera including a lens and an image sensor, the image sensor having an array of pixels on a sensor plane, the lens configured to receive a second light and to image the second light onto the image sensor, the second light being a reflection of the first light from the surface, the image sensor further configured to send a first electrical signal to the first processor in response to receiving the second light, the first processor coupled to the image sensor and configured to determine a plurality of centroids based at least in part on the first electrical signal, there being a baseline distance between the projector and the camera; and a second processor, external to the housing, configured to receive the position signals from the transducers and to receive the plurality of centroids from the first processor, the second processor further configured to determine and store, or transmit to an external device, the three-dimensional coordinates a plurality of points on the surface, the three-dimensional coordinates based at least part on the position signals, the received centroid data, and the baseline distance.

According to one embodiment of the invention, a method is provided for determining three-dimensional coordinates of points on a surface on an object. The method includes providing a device that includes a manually positionable articulated arm portion, a base section, a probe assembly, and a second processor, the arm portion having opposed first and second ends, the arm portion including a plurality of connected arm segments, each arm segment including at least one position transducer for producing a position signal, the base section connected to the second end, the probe assembly connected to the first end, the probe assembly including a housing, a first processor, a projector, and a camera, the projector disposed within the housing, the projector having a light source configured to emit a first light onto a surface of the object, the projector being configured to project the first light to form a line on a plan arranged perpendicular to the direction of propagation of the light, the camera arranged within the housing, the camera including a lens and an image sensor, the image sensor having an array of pixels on a sensor plane, the first processor coupled to the image sensor, there being a baseline distance between the projector and the camera, the second processor external to the housing; emitting from the projector the first light onto the surface; receiving with the lens a second light, the second light being a reflection of the first light from the surface; imaging with the lens the second light onto the sensor plane and, in response, sending a first electrical signal to the first processor; determining with the first processor a plurality of centroids of the points on the surface, the plurality of centroids based at least in part on the first electrical signal; receiving with the second processor the plurality of centroids; determining with the second processor the three-dimensional coordinates of the points on the surface based at least in part on the position signals, the plurality of centroids, and the baseline distance; and storing the three-dimensional coordinates of the points on the surface.

### BRIEF DESCRIPTION OF THE DRAWINGS

Referring now to the drawings, exemplary embodiments are shown which should not be construed to be limiting regarding the entire scope of the disclosure, and wherein the elements are numbered alike in several FIGURES:

FIG. 1 is a perspective view of a non-contact measurement device according to an embodiment of the invention;

FIG. 2 is a cross-sectional view of a non-contact measurement device according to an embodiment of the invention;

FIG. 3 is a top view of a non-contact measurement device according to an embodiment of the invention;

FIG. 4 is a schematic diagram of a non-contact measurement device according to an embodiment of the invention;

FIG. 5 is a schematic view illustrating operation of the non-contact measurement device of FIGS. 1-3;

FIG. 6 is another schematic view illustrating operation of the non-contact measurement device of FIGS. 1-3;

FIG. 7 including FIGS. 7A and 7B, are perspective views of a portable articulated arm coordinate measuring machine (AACMM) configured for use in conjunction with a non-contact measurement device; and

FIG. 8 is a schematic diagram illustrating how the non-contact measurement device of FIGS. 1-3 determines distance from the non-contact measurement device to an object in accordance with an embodiment of the invention.

### DETAILED DESCRIPTION

Laser scanners and laser line probes (LLP) are used in a variety of applications to determine surface point coordinates and a computer image of an object. Embodiments of the present invention provide advantages in improving the resolution and accuracy of the measurements. Embodiments of the present invention provide still further advantages in providing the non-contact measurement of an object. Embodiments of the present invention provide advantages in reducing the calculation time for determining coordinates values for surface points.

As used herein, the term “structured light” refers to a two-dimensional pattern of light projected onto a continuous and enclosed area of an object that conveys information which may be used to determine coordinates of points on the object. A structured light pattern will contain at least three non-collinear pattern elements disposed within the contiguous and enclosed area. Each of the three non-collinear pattern elements conveys information which may be used to determine the point coordinates.

In general, there are two types of structured light, a coded light pattern and an uncoded light pattern. As used herein a coded light pattern is one in which the three dimensional coordinates of an illuminated surface of the object may be ascertained by the acquisition of a single image. In some cases, the projecting device may be moving relative to the object. In other words, for a coded light pattern there will be no significant temporal relationship between the projected pattern and the acquired image. Typically, a coded light pattern will contain a set of elements (e.g. geometric shapes) arranged so that at least three of the elements are non-collinear. In some cases, the set of elements may be arranged into collections of lines. Having at least three of the elements be non-collinear ensures that the pattern is not a simple line pattern as would be projected, for example, by an LLP. As a result, the pattern elements are recognizable because of the arrangement of the elements.

In contrast, an uncoded structured light pattern as used herein is a pattern that does not allow measurement through a single pattern when the projector is moving relative to the object. An example of an uncoded light pattern is one which utilizes a series of sequential patterns and thus the acquisition of a series of sequential images. Due to the temporal nature of the projection pattern and acquisition of the image, there should be no relative movement between the projector and the object.

It should be appreciated that structured light is different from light projected by a LLP or similar type of device that generates a line of light. To the extent that LLPs used with articulated arms today have irregularities or other aspects that may be regarded as features within the generated lines, these features are disposed in a collinear arrangement. Consequently such features within a single generated line are not considered to make the projected light into structured light.

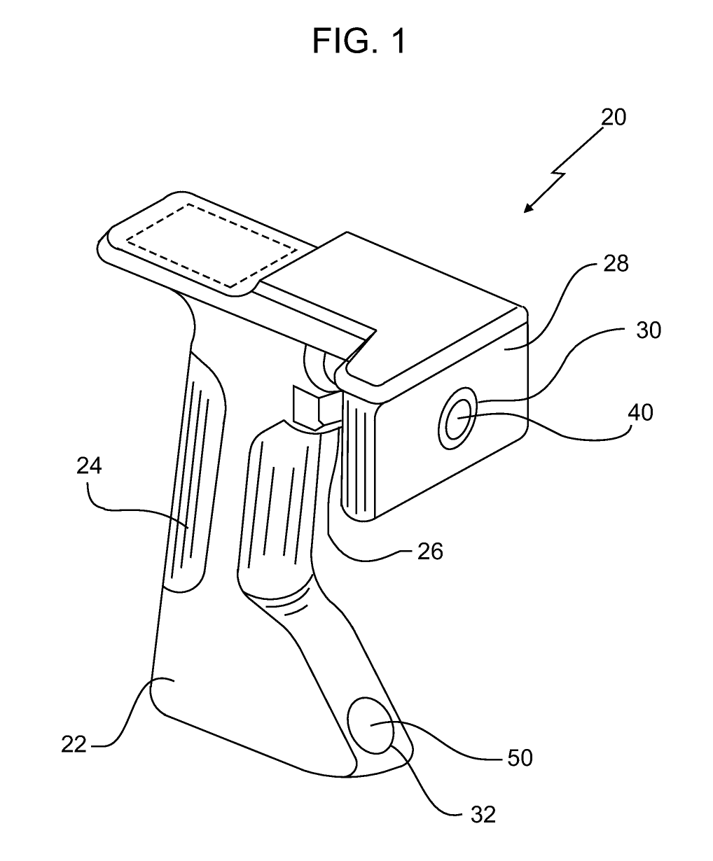

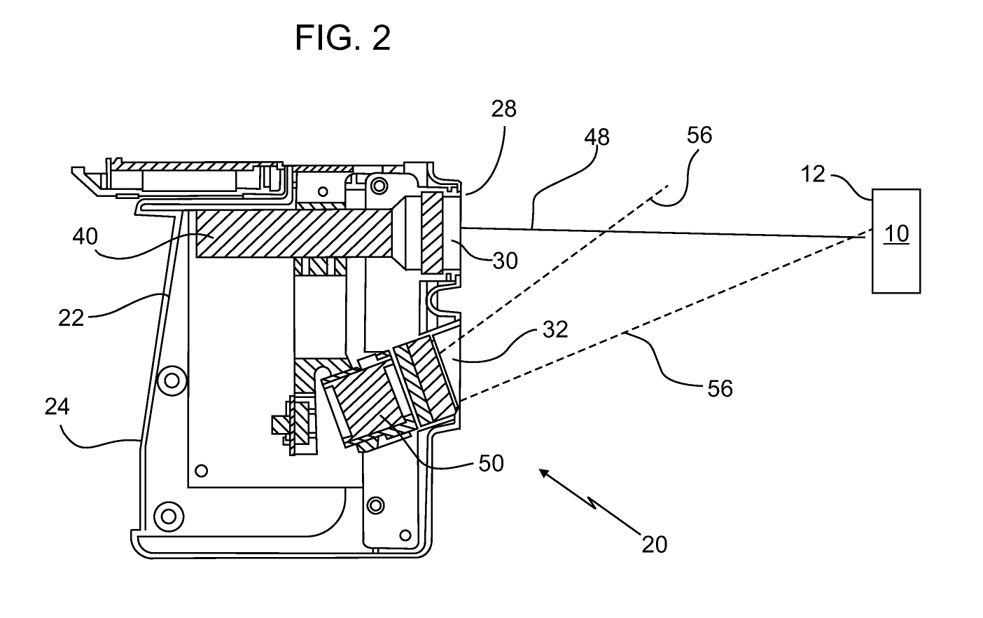

FIGS. 1-6 illustrate a non-contact measurement device 20, such as a laser line probe (LLP) or a laser scanner for example, configured for use by an operator to measure a surface 12 of an object 10 (FIG. 2). The non-contact measurement device 20 includes a housing 22 having a handle portion 24 that is sized and shaped to be gripped by the operator. In one embodiment, the handle 24 includes one or more buttons or actuators 26 that may be manually activated to operate the non-contact measurement device 20. Formed within a first side 28 of the housing 22 are at least a first opening 30 and a second opening 32 spaced apart by either a vertical or a horizontal distance.

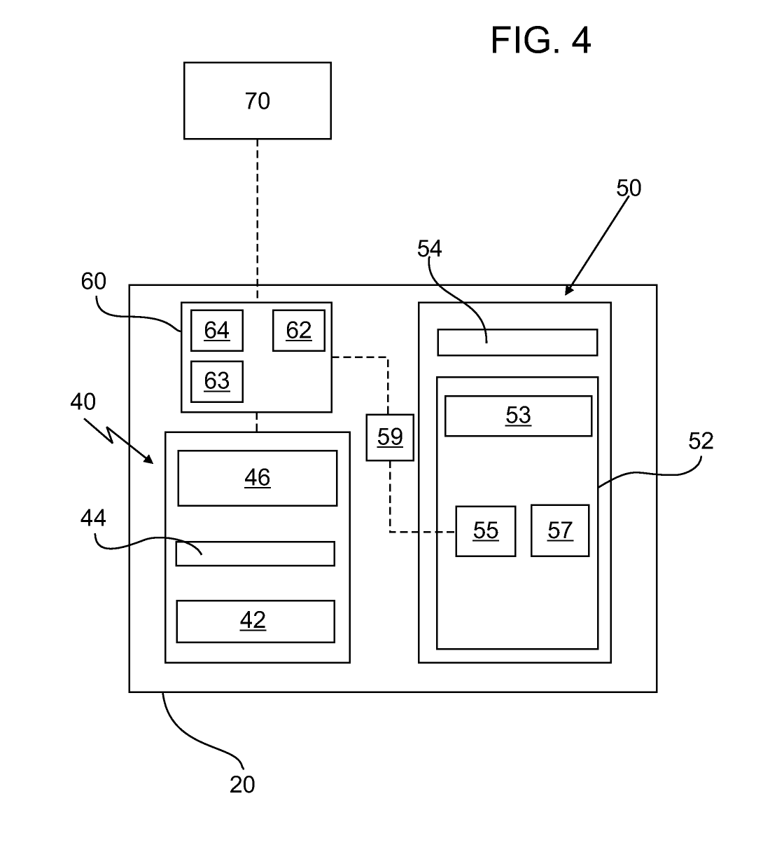

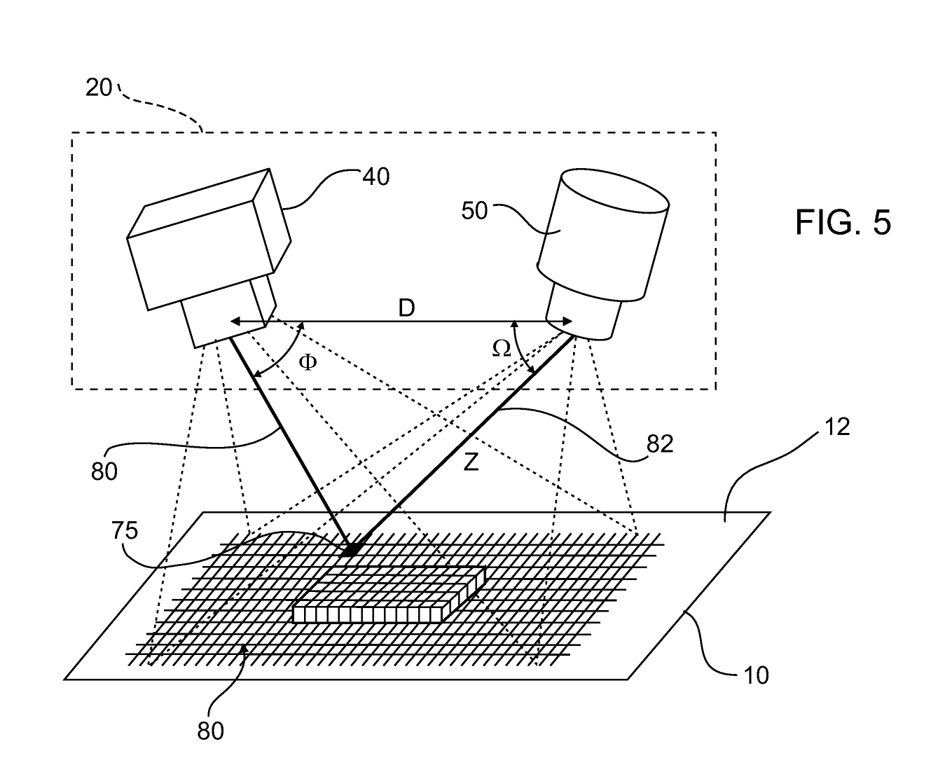

Arranged within the housing 22 of the non-contact measurement device 20 is a pair of optical devices, such as a projector 40 and a camera 50 (FIG. 2) for example, that project a light and receive a light that was reflected from an object 10 respectively. The projector 40 may include a visible light source 42 (FIG. 4) for illuminating the surface 12 of an object 10. Exemplary light sources 42 include, but are not limited to a laser, a super luminescent diode, an incandescent light, a light emitting diode (LED), or other light emitting device for example. The projector 40 is arranged adjacent to and generally aligned with the first opening 30 of the housing 22 such that light from the visible light source 42 is emitted there through. In embodiments where the non-contact measurement device 20 is a laser scanner, the projector 40 also includes a pattern generator 44, such that light from the visible light source 42 may be directed through the pattern generator 44 to create a light pattern that is projected on to the surface 12 being measured (FIG. 5). The pattern generator 44 may be a chrome-on-glass slide having an etched structured light pattern, a digital micro-mirror device (DMD) such as a digital light projector (DLP) manufactured by Texas Instruments Corporation, a liquid crystal device (LCD), a liquid crystal on silicon (LCOS) device, or a similar device for example. Any of these devices may be used in either a transmission mode or a reflection mode. The projector 40 may further include a lens system 46 configured to alter the outgoing light to have desired focal characteristics.

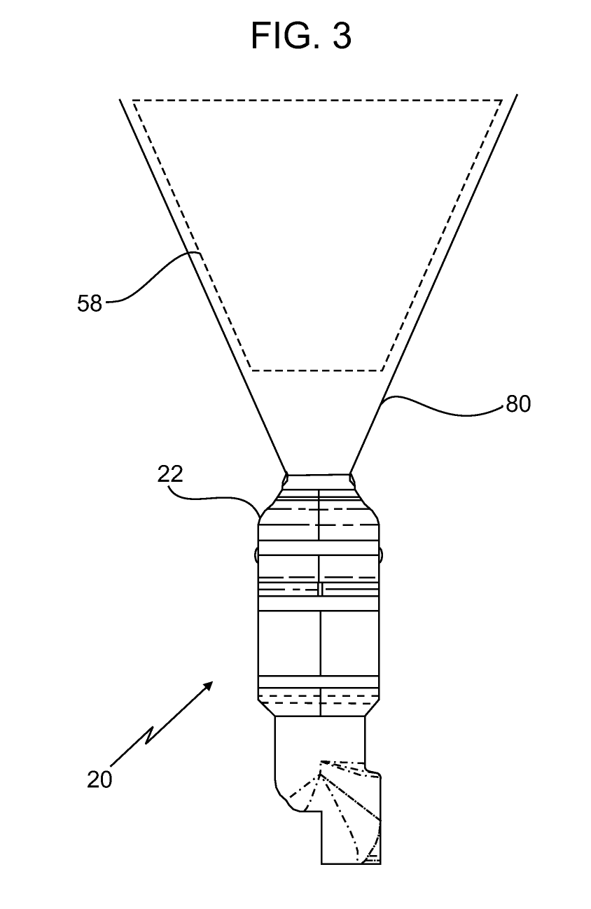

The camera 50 includes a photosensitive or image sensor 52 (FIG. 3) which generates an electrical signal of digital data representing the image captured by the sensor 52. The sensor 52 may be a charge-coupled device (CCD) type sensor or a complementary metal-oxide-semiconductor (CMOS) type sensor for example, having an array 53 of pixels. In other embodiments, the sensor 52 may be a light field sensor, a high dynamic range system, or a quantum dot image sensor for example. The camera 50 may further include other components, such as a lens 54 for imaging the reflected light onto the image sensor 52 and other optical devices for example. In one embodiment, the lens 54 is arranged within the second opening 32 (FIG. 2) of the housing 22. The camera 50 is positioned adjacent to and substantially aligned with the second opening 32 of the housing 22. The second opening 32, and therefore the camera 50, is arranged at an angle relative to the first opening 30 and the projector 40 so that the light emitted by the light source 42 reflects off of the surface 12 of the object 10 toward the photosensitive sensor 52 of the camera 50.

As illustrated schematically in FIG. 4, the sensor 52 additionally includes one or more microprocessors 55 and nonvolatile memory 57. The processor 55 controls the capture of images on the photosensitive sensor 52 by the camera 50, as well as the processing of those images to determine a center of gravity (COG) for the arrays of pixels of an image. The determined COG may then be stored within the memory 57. The processor 55 of the sensor 52 is operably coupled to a controller 60 positioned within the housing 22 of the non-contact measurement device 20, for example via a communication bus 59. The controller 60 includes one or more microprocessors 62, digital signal processors, nonvolatile memory 63, volatile member 64, communications circuits and signal conditioning circuits. The controller 60 receives the COG calculated for each of the captured images, and processes those to determine the X, Y, Z coordinate data for at least one point on the surface 12 of the object 10. In the exemplary embodiment, only the COG data is transferred to the controller 60 and the captured images are discarded by the processor 55 once the COG data is transmitted. In one embodiment, the controller 60 is configured to communicate with an external device 70, by either a wired or wireless communication medium. Processed coordinate data may also be stored in memory 64 and transferred either periodically or aperiodically. The transfer of processed coordinate data may occur automatically or in response to a manual operation by the operator (e.g. transferring via flash drive). It should further be appreciated that by determining the COG in the processor 55, advantages in processing speed are gained over prior art systems which transferred the acquired images (e.g. large data volume) to the controller 60 since the bandwidth constraints of the communication bus 59 are avoided.

It should be appreciated that while embodiments herein refer to the device 20 as being a handheld device, this is for exemplary purposes and the claimed invention should not be so limited. In other embodiments, the non-contact measurement device 20 may be mounted to a fixture, such as a robot for example. In other embodiments, the device 20 may be stationary and the object being measured may move relative to the device, such as in a manufacturing inspection process or with a game controller for example.

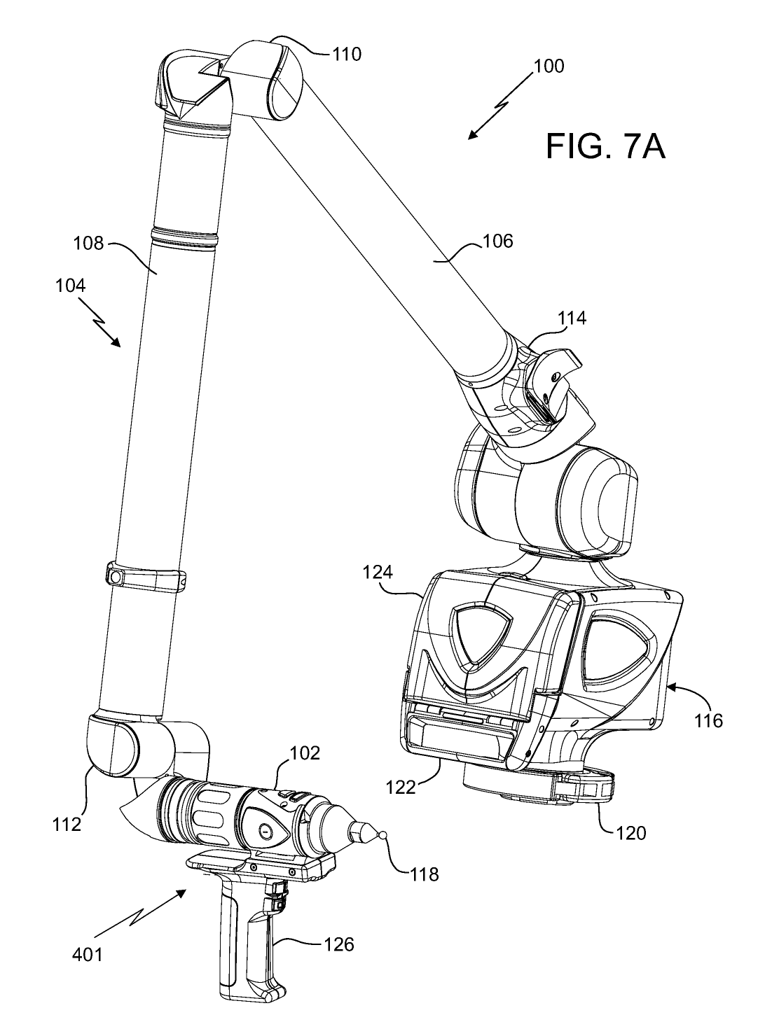

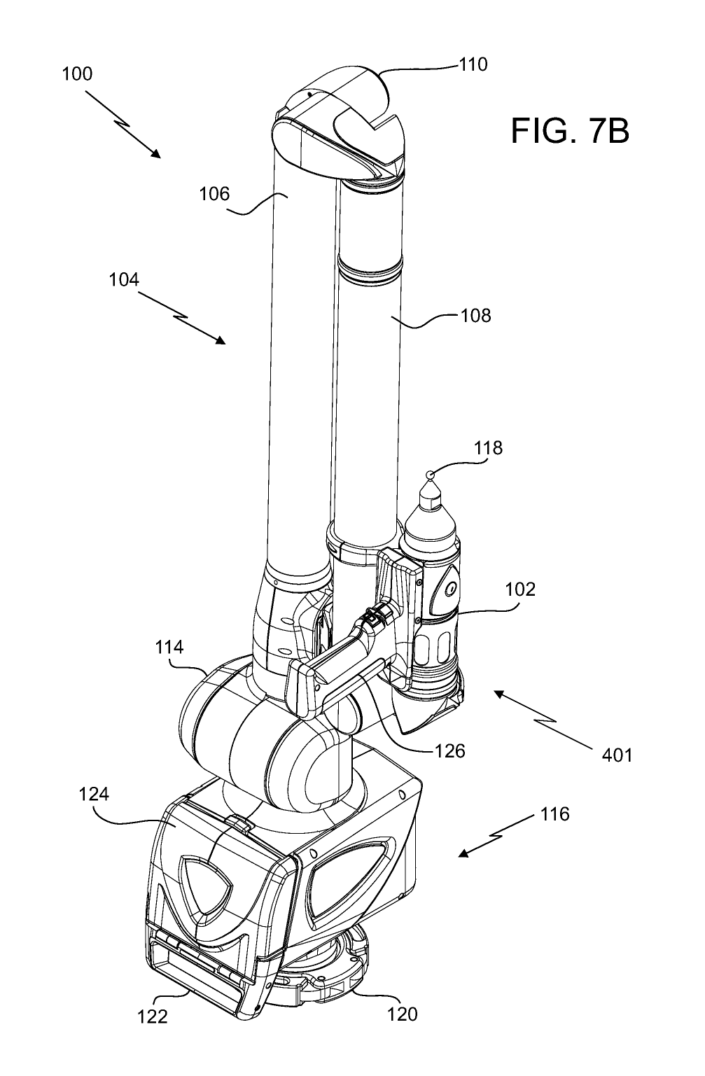

In one embodiment, the external device 70 operably coupled to the controller 60 is a portable articulate arm coordinate measuring machine (AACMM), as illustrated in FIGS. 7A and 7B. The AACMM 100 includes a multiple axis articulated measurement device having a probe end 401 that includes a measurement probe housing 102 coupled to an end of an arm portion 104. The arm portion 104 includes a plurality of arm segments 106, 108 coupled to one another and to a base 116 and a measurement probe housing 102 by groups of bearing cartridges 110, 112, 114. Though the illustrated AACMM 100 includes a first arm segment 106 and a second arm segment 108, the external device configured for use with the non-contact measurement device 20 may include any number of arm segments coupled together by bearing cartridges, and thus, more or less than six or seven axes of articulated movement or degrees of freedom. When combined into a group 110, 112, 114, the bearing cartridges may form a hinge and swivel type of connector such that an adjoining component is independently movable about two axes. The measurement probe housing 102 may comprise the shaft of an additional axis of the AACMM 100 (e.g. a cartridge containing an encoder system that determines movement of the measurement device, for example a probe 118, of the AACMM 100.) In this embodiment, the probe end 401 may rotate about an axis extending through the center of measurement probe housing 102. In use of the AACMM 100, the base 116 is typically affixed to a planar work surface.

The measurement probe 102 housing includes a detachably mounted handle, connected to the housing 102 by way of, for example, a quick connect interface. The handle may be replaced with another attachment, such as a bar code reader or paint sprayer for example to provide additional functionality to the AACMM. In one embodiment, the non-contact measurement device 20 is configured to couple to the probe housing 102 in place of the handle, such as with a quick connect interface for example.

The base 116 may include an attachment device or mounting device 120. The mounting device 120 allows the AACMM 100 to be removably mounted to a desired location, such as an inspection table, a machining center, a wall or the floor for example. In one embodiment, the base 116 includes a handle portion 122 that provides a convenient location for the operator to hold the base 116 as the AACMM 100 is being moved. In one embodiment, the base 116 further includes a movable cover portion 124 that folds down to reveal a user interface, such as a display screen for example. The base 116 of the portable AACMM 100 generally contains or houses an electronic data processing system that includes two primary components: a base processing system that processes the data from the various encoder systems within the AACMM 100 as well as data representing other arm parameters to support three-dimensional (3-D) positional calculations; and a user interface processing system that includes an on-board operating system, a touch screen display, and resident application software that allows for relatively complete metrology functions to be implemented within the AACMM 100 without the need for connection to an external computer. It should be appreciated that coupling the device 20 to the probe housing 102 provides advantages in that the position and orientation of the device 20 is known by the electronic data processing system 210, so that the location of the object 10 relative to the AACMM 100 may also be ascertained. In one embodiment, the external device 70 is integrated into the electronic data processing system contained in the AACMM 100.

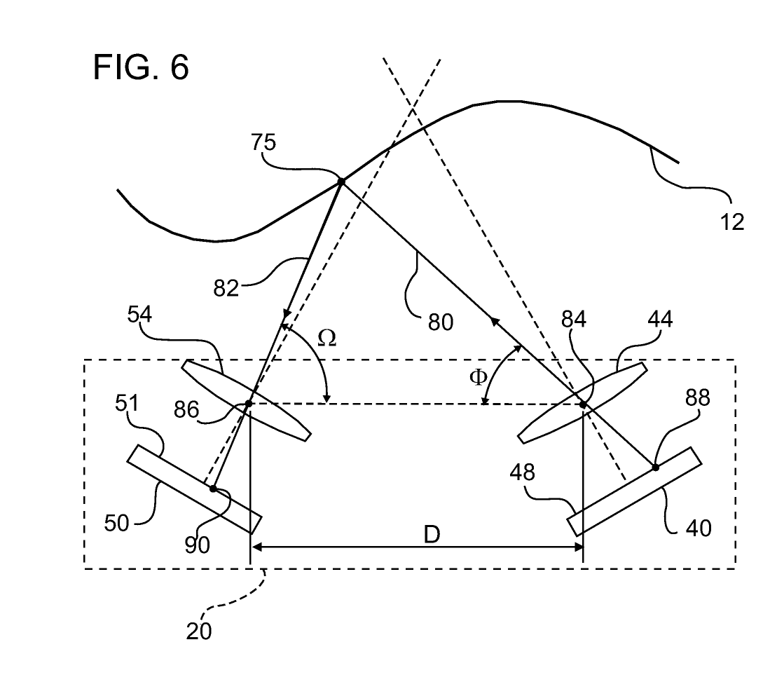

Referring again to the non-contact measurement device 20 of FIGS. 1-6, the visible light source 42 of the projector 40 is arranged such that light is emitted from the housing 22 in a plane 48 (FIG. 6) perpendicular to the page as shown in FIG. 2, and parallel to the page as shown in FIG. 3, which shows a top-view of a non-contact measurement device 20. The field of view (FOV) of the camera 50, illustrated by dashed lines 56 in FIG. 2, intersects the plane 48 defined by the light within the area 58 illustrated by dashed lines in FIG. 3. As will therefore be appreciated, when an object 10 is passed through area 58, the locus of points on the object 10 intersecting the area 58 that face towards the non-contact measurement device 20 will be illuminated by the light and imaged by the camera 50. In other embodiments of the present invention, the non-contact measurement device 20 includes more than one camera. The use of multiple cameras may provide advantages in some applications by providing redundant images to increase the accuracy of the measurement. In still other embodiments, the redundant images may allow for sequential patterns to be quickly acquired by the device by increase the acquisition speed of images by alternately operating the camera.

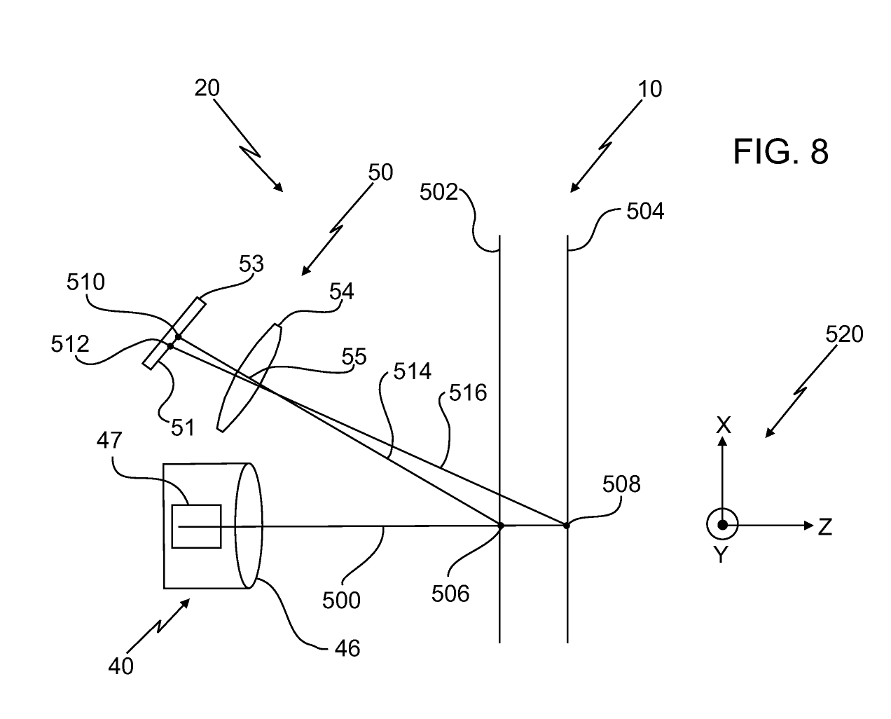

Referring now to FIG. 8, a top view of a non-contact measurement device, such as a Laser Line probe (LLP) includes a projector 40 and a camera 50. The camera includes a lens system 54 and a photosensitive sensor 52 having a photosensitive array 53 and the projector 40 includes a lens system 46 and a line generator 47. The camera 50 may be configured to capture images or a sequence of video frames of the illuminated surface of the photosensitive sensor 52. It should be appreciated that variations in the surface 12 of the object 10, such as a protrusion for example, create distortions in the light when the image of the light is captured by the camera 50.

The projector 40 projects a line 500 (shown in the FIG. as projecting out of the plane of the paper) onto the surface 12 of an object 10, which may be located at a first position 502 or a second position 504. The line of light emitted by the projector 40 is defined by the line formed on a plane arranged generally perpendicular to the direction of propagation of the light. Light scattered from the object 10 at the first point 506 travels through a perspective center 55 of the lens system 54 to arrive at the photosensitive array of pixels 53 at position 510. Light scattered from the object 10 at the second position 508 travels through the perspective center 55 to arrive at position 512. By knowing the relative positions and orientations of the projector 40, the camera lens system 54, the photosensitive array 53, and the position 510 on the photosensitive array 53, it is possible to calculate the three dimensional coordinates of the point 506 on the object surface 12. Similarly, knowledge of the relative position of the point 512, rather than 510 will yield the three dimensional coordinate of the point 508. The photosensitive array 53 may be tilted at an angle to satisfy the Scheimpflug principle, thereby helping to keep the line of light on the object surface in focus on the array.

One of the calculations described herein above yields information about the distance of the object 10 from the measurement device 20, in other words, the distance in the z direction, as indicated by the coordinate system 520 of FIG. 8. The information about the x position and y position of each point 506 or 508 relative to the measurement device 20 is obtained by the other dimension of the photosensitive array 53, in other words, the y dimension of the photosensitive array 53. Since the plane that defines the line of light as it propagates from the projector 40 to the object 10 is known from the coordinate measuring capability of the articulated arm 100, it follows that the x position of the point 506 or 508 on the object surface 12 is also known. Hence all three coordinates—x, y, and z—of a point on the object surface 12 can be found from the pattern of light on the 2D array 53.

Each image captured by the camera 50 depicts a laser line constituting pixels on the array 53 of sensor 52 at which the light ray 514, 516 is detected. A one to one correspondence exists between pixels of the emitted light beam 500 and pixels in the imaged laser line 514, 516. The points in the imaged laser line 514, 516 are located in the plane 51 of the sensor 52 and are used to determine corresponding points of the emitted light beam 500 based on calibration data for the non-contact measurement device 20. For example, the photosensitive sensor 52 (FIG. 4) may constitute a 1280×960 pixel array 53, wherein, each of the 1,228,800 pixels of the array is designated by a point (x,y) in the camera plane 51, and a corresponding point (X,Y) in the plane 48 of the projector 40.

The captured images are then processed by the processor 55 coupled to the sensor 52. Each image is used to determine the location of the measured object 10 with sub-pixel accuracy. This is possible because the profile across the laser line approximates a Gaussian function and extends across multiple rows of pixels on the photosensitive sensor 52 image plane. The processor 55 further analyzes the profile of the imaged laser line to determine a center of gravity (COG) thereof, which is the point that best represents the exact location of the line. In one embodiment, the processor 55 determines a COG for each column of pixels in the array 53. The COG is a weighted average calculated based on the intensity of light measured at each pixel in the imaged laser line. Consequently, pixels having a higher intensity are given more weight in the COG calculation because the emitted light beams 500, and therefore the imaged laser line, are brightest at a center. If the light ray 514, 516 reflected from the surface 12 of the object 10 towards the camera 50 does not have enough light, the processor 55 will not be able to calculate a COG from the imaged laser line. Similarly, if the image is overexposed, thereby including an excess of in-band light, the processor 55 will not be able to calculate a COG from the imaged laser line.

Once the image is processed, the image is discarded and the processed COG data is transferred to the controller processer 62 where the three dimensional coordinates are calculated. It should be appreciated that the communication bus 59 between the processor 55 coupled to the sensor 52 and the controller 60 has a limited bandwidth. It should further be appreciated that by determining the COG in the processor 55, advantages in processing speed are gained over prior art systems which transferred the acquired images (e.g. large data volume) to the controller 60.

Referring now to FIGS. 5 and 6, in embodiments where the non-contact measurement device 20 is a laser scanner, the device 20 uses triangulation-based methods based on the emitted light and the acquired image of the reflected light to determine a point cloud representing the X, Y, Z coordinate data for the object 10 for each pixel of a received image. The light 80 emitted by the visible light source 42 is a structured light pattern.

The device first emits a structure light pattern with projector 40 having a projector plane which projects the pattern through a center 84 of the lens 46 and onto surface 12 of the object 10. The light from the pattern is reflected from the surface 12 and the reflected light 82 is received through the center 86 of lens 54 by a photosensitive array 53 of sensor 52 in the camera 50. Since the pattern is formed by structured light, it is possible in some instances for the processor 55 to determine a one to one correspondence between the pixels in the emitted pattern 80, such as pixel 88 for example, and the pixels in the imaged pattern, such as pixel 90 for example. This correspondence enables the processor 62 to use triangulation principals to determine the coordinates of each pixel in the imaged pattern. The collection of three-dimensional coordinates of points on the surface 12 is sometimes referred to as a point cloud. By moving the scanner 20 over the surface 12 (or moving the surface 12 past the scanner 20), a point cloud may be created of the entire object 10.

For each of the elements in the structured light pattern, at least one centroid or COG is determined. Similar to as described above, with reference to the laser light probe (LLP), the centroid values are calculated by the first processor 55 directly coupled to the sensor array 53. These centroid/COG values, rather than the images, are then transmitted via a wired or wireless bus 59 to the controller 60 where a second processor 62 determines the three-dimensional coordinates. However, if the pattern reflected from the surface 12 of the object 10 towards the camera 50 does not have enough light, the processor 55 will not be able to calculate a centroid from the imaged structured light pattern. Similarly, if the image is overexposed and includes an excess of in-band light, the processor 55 will not be able to calculate a centroid from the imaged structured light pattern.

The processor 62 decodes the centroids of the acquired image to determine the three-dimensional coordinates of the object 10. To determine the coordinates of a centroid, the angle of each projected ray of light 80 intersecting the object 10 at a point 75 is known to correspond to a projection angle phi (Φ), so that Φ information is encoded into the emitted pattern. In an embodiment, the system is configured to enable the Φ value corresponding to each pixel in the imaged pattern to be ascertained. Further, an angle omega (Ω) for each pixel in the camera 50 is known, as is the baseline distance “D” between the projector 40 and the camera 50. Since the two angles Ω, Φ and the distance D between the projector 40 and camera 50 are known, the distance Z to point 75 on the object 10 may be determined. With the distance Z known, the three-dimensional coordinates may be calculated for each surface point in the acquired image.

By including center of gravity/centroid processing functionality within the processor 55 of the sensor 52, the overall efficiency of the non-contact measurement device 20 is improved. Only processed center of gravity or centroid data, and not the acquired image, will be transmitted to the second processor 62 of controller 60. Because center of gravity or centroid data is much smaller and less complex than an image, the size and therefore the amount of time required to transmit the processed data to the controller over a conventional communication bus 59 is significantly reduced.

Embodiments of the LLP 500 have been described herein as being included within an accessory device or as an attachment to a portable AACMM 100. However, this is for exemplary purposes and the claimed invention should not be so limited. Other embodiments of the LLP 500 are contemplated by the present invention, in light of the teachings herein. For example, the LLP may be utilized in a fixed or non-articulated arm (i.e., non-moving) CMM. Other fixed inspection installations are contemplated as well. For example, a number of such LLPs 500 may be strategically placed in fixed locations for inspection or measurement purposes along some type of assembly or production line; for example, for automobiles.

While the invention has been described with reference to example embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A portable coordinate measuring machine for measuring three-dimensional coordinates of an object in space, the coordinate measuring machine comprising:
a manually positionable articulated arm portion having opposed first and second ends, the arm portion including a plurality of connected arm segments, each arm segment including at least one position transducer for producing a position signal;
a base section connected to the second end;
a probe assembly connected to the first end, the probe assembly including:
a housing;
a first processor disposed within the housing;
a projector disposed within the housing, the projector having a light source configured to emit a first light onto a surface of the object, wherein the projector is configured to project the first light to form a line on a plane arranged perpendicular to the direction of propagation of the first light;
a camera arranged within the housing, the camera including a lens and an image sensor, the image sensor having an array of pixels on a sensor plane, the lens configured to receive a second light and to image the second light onto the image sensor, the second light being a reflection of the first light from the surface, the image sensor further configured to send a first electrical signal to the first processor in response to receiving the second light, the first processor coupled to the image sensor and configured to determine a plurality of centroids based at least in part on the first electrical signal, there being a baseline distance between the projector and the camera; and
a second processor, external to the housing, configured to receive the position signals from the transducers and to receive the plurality of centroids from the first processor, the second processor further configured to determine and store, or transmit to an external device, the three-dimensional coordinates a plurality of points on the surface, the three-dimensional coordinates based at least part on the position signals, the received centroid data, and the baseline distance.

2. The portable coordinate measuring machine according to claim 1, wherein the projector includes a pattern generator positioned adjacent the light source such that the light emitted by the light source is directed through the pattern generator.

3. A method of determining three-dimensional coordinates of points on a surface on an object, the method comprising:
providing a device that includes a manually positionable articulated arm portion, a base section, a probe assembly, and a second processor, the arm portion having opposed first and second ends, the arm portion including a plurality of connected arm segments, each arm segment including at least one position transducer for producing a position signal, the base section connected to the second end, the probe assembly connected to the first end, the probe assembly including a housing, a first processor, a projector, and a camera, the projector disposed within the housing, the projector having a light source configured to emit a first light on the surface of the object, the projector being configured to project the first light to form a line on a plane arranged perpendicular to the direction of propagation of the first light, the camera arranged within the housing, the camera including a lens and an image sensor, the image sensor having an array of pixels on a sensor plane, the first processor coupled to the image sensor, there being a baseline distance between the projector and the camera, the second processor external to the housing;
emitting from the projector the first light onto the surface;
receiving with the lens a second light, the second light being a reflection of the first light from the surface;
imaging with the lens the second light onto the sensor plane and, in response, sending a first electrical signal to the first processor;
determining with the first processor a plurality of centroids of the points on the surface, the plurality of centroids based at least in part on the first electrical signal;
receiving with the second processor the plurality of centroids;
determining with the second processor the three-dimensional coordinates of the points on the surface based at least in part on the position signals, the plurality of centroids, and the baseline distance; and
storing the three-dimensional coordinates of the points on the surface.

4. The method according to claim 3 wherein, in the step of determining with the second processor the three-dimensional coordinates of the points on the surface, the first processor calculates a centroid for each column of pixels.

5. The method according to claim 4 wherein, in the step of providing a device, the first processor is operably coupled to the second processor via a communication bus.

6. The method according to claim 5, further comprising communicating the three-dimensional coordinates to an external device.
